(19) United States
(12) Patent Application Publication
(10) Pub. No.: US 2026/0212865 A1
(43) Pub. Date: Jul. 23, 2026

(54) INTERACTION METHOD AND APPARATUS, ELECTRONIC DEVICE, AND COMPUTER-READABLE STORAGE MEDIUM

(71) Applicant: Beijing Zitiao Network Technology Co., Ltd., Beijing (CN)

(72) Inventors: Yifan DING, Beijing (CN); Jiayi ZHAO, Beijing (CN); Ziyang ZHENG, Beijing (CN)

(21) Appl. No.: 19/446,822

(22) Filed: Jan. 12, 2026

(30) Foreign Application Priority Data
Jan. 23, 2025 (CN) 202510113409.2

(51) Int. Cl. G10L 15/22; H04M 3/42; H04N 23/60

(52) U.S. Cl. CPC G10L 15/22; H04M 3/42; H04N 23/60

(57) ABSTRACT

The present disclosure relates to an interaction method and apparatus, an electronic device, and a computer-readable storage medium. The interaction method includes: entering a first voice mode in response to a first operation of a user, where maintaining the first voice mode does not require manual operation of the user; making an instant call with the user in the first voice mode; receiving visual information and voice information input by the user in the first voice mode; and generating reply information based on the visual information and the voice information input by the user.

### CROSS-REFERENCE TO RELATED APPLICATIONS

This application claims priority to Chinese Patent Application No. 202510113409.2 filed on January 23, 2025. The entire disclosure of the prior application is incorporated herein by reference in its entirety.

### TECHNICAL FIELD

The present disclosure relates to the field of computer technologies, and in particular, to an interaction method and apparatus, an electronic device, and a computer-readable storage medium.

### BACKGROUND

A voice assistant is an artificial intelligence application or intelligent device based on voice interaction technology. The voice assistant may recognize and understand human voice instructions, perform processing by using predefined rules or artificial intelligence algorithms, and make corresponding feedback or perform related operations in voice or other manners, to provide various services and assistance for users.

The voice assistant may recognize voice content of a user, understand intention therein, and reply in natural and smooth voice, to implement conversation similar to that between humans.

### SUMMARY

According to some embodiments of the present disclosure, an interaction method is provided. The method includes: entering a first voice mode in response to a first operation of a user, where maintaining the first voice mode does not require manual operation of the user; making an instant call with the user in the first voice mode; receiving visual information and voice information input by the user in the first voice mode; and generating reply information based on the visual information and the voice information input by the user.

According to some other embodiments of the present disclosure, an interaction apparatus is provided. The apparatus includes: a first module configured to enter a first voice mode in response to a first operation of a user, where maintaining the first voice mode does not require manual operation of the user; a second module configured to make an instant call with the user in the first voice mode; a third module configured to receive visual information and voice information input by the user in the first voice mode; and a fourth module configured to generate reply information based on the visual information and the voice information input by the user.

According to some other embodiments of the present disclosure, an electronic device is provided. The electronic device includes: a memory; and a processor coupled to the memory, where the processor is configured to, based on instructions stored in the memory, execute the interaction method according to some embodiments of the present disclosure.

According to some other embodiments of the present disclosure, a computer-readable storage medium is provided. The computer-readable storage medium has computer program instructions stored thereon, where when the instructions are executed by a processor, the interaction method according to some embodiments of the present disclosure is implemented.

According to some other embodiments of the present disclosure, a computer program product is provided. The computer program product includes computer program instructions, where when the computer program instructions are executed by a processor, the interaction method according to some embodiments of the present disclosure is implemented.

Other features, aspects, and advantages of the present disclosure become apparent with reference to the following detailed description of the exemplary embodiments of the present disclosure.

### BRIEF DESCRIPTION OF THE DRAWINGS

Embodiments of the present disclosure are described below with reference to the drawings. It should be understood that the drawings in the following description relate to only some embodiments of the present disclosure, but do not constitute a limitation to the present disclosure. In the drawings:

FIG. 1 is a flowchart of an interaction method according to some embodiments of the present disclosure;

FIGS. 2A to 2C are schematic diagrams of entering a first voice mode according to some embodiments of the present disclosure;

FIGS. 3A to 3D are schematic diagrams of a call interface according to some embodiments of the present disclosure;

FIGS. 4A to 4C are schematic diagrams of inputting visual information according to some embodiments of the present disclosure;

FIG. 5 is a schematic diagram of a third operation according to some embodiments of the present disclosure;

FIG. 6 is a schematic diagram of running a first voice mode in the background according to some embodiments of the present disclosure;

FIG. 7 is a schematic diagram of a third voice mode according to some embodiments of the present disclosure;

FIG. 8 is a block diagram of an interaction apparatus according to some embodiments of the present disclosure;

FIG. 9 is a block diagram of an electronic device according to some embodiments of the present disclosure;

FIG. 10 is a block diagram of an electronic device according to some other embodiments of the present disclosure.

It should be understood that, for ease of description, the dimensions of various parts shown in the drawings are not necessarily drawn to scale. Throughout the drawings, the same or similar reference numerals denote the same or similar components. Therefore, once an item is defined in one drawing, it may not be further discussed in subsequent drawings.

### DETAILED DESCRIPTION OF EMBODIMENTS

The technical solutions in the embodiments of the present disclosure are clearly and completely described below with reference to the drawings in the embodiments of the present disclosure. It should be understood that the present disclosure may be implemented in various forms, and should not be construed as being limited to the embodiments set forth herein.

It should be understood that the various steps recited in the method implementations of the present disclosure may be performed in a different order, and/or performed in parallel. In addition, the method implementations may include additional steps and/or omit performing the illustrated steps. The scope of the present disclosure is not limited in this respect. Unless otherwise specifically stated, the relative arrangements, numerical expressions, and numerical values of the components and steps set forth in these embodiments are to be construed as merely exemplary and do not limit the scope of the present disclosure.

The term "include/comprise" and its variants used in the present disclosure are open-ended terms that mean "include/comprise at least the following elements/features, but do not exclude other elements/features", that is, "include/comprise but not limited to". The term "based on" means "based at least in part on".

It should be noted that concepts such as "first" and "second" mentioned in the present disclosure are merely used to distinguish between different apparatuses, modules, or units, and are not used to limit the order or interdependence of the functions performed by these apparatuses, modules, or units. Unless otherwise specified, concepts such as "first" and "second" are not intended to imply that the objects so described must be in a given order in terms of time, space, ranking, or in any other manner.

It should be noted that the modifications of "one" and "a plurality of" mentioned in the present disclosure are exemplary rather than restrictive, and those skilled in the art should understand that unless clearly indicated in the context, they should be understood as "one or more".

The names of messages or information exchanged between a plurality of apparatuses in the implementations of the present disclosure are used for illustrative purposes only, and are not used to limit the scope of the messages or information.

Embodiments of the present disclosure are described in detail below with reference to the drawings, but the present disclosure is not limited to these specific embodiments. The following specific embodiments may be combined with each other, and the same or similar concepts or processes may not be described in detail in some embodiments. In addition, in one or more embodiments, a particular feature, structure, or characteristic may be combined in any suitable manner that will be clear to those of ordinary skill in the art from this disclosure.

It should be understood that the present disclosure also does not limit how to obtain the image to be applied/processed. In some embodiments of the present disclosure, the image may be obtained from a storage apparatus, for example, an internal memory or an external storage apparatus. In some other embodiments of the present disclosure, a photographing component may be mobilized to take a picture. It should be noted that the obtained image may be a captured image or a frame of image in a captured video, which is not particularly limited thereto.

In the context of the present disclosure, an image may refer to any of a variety of images, such as a color image, a grayscale image, or the like. It should be noted that in the context of this specification, the type of the image is not particularly limited. In addition, the image may be any appropriate image, such as an original image obtained by a photographing apparatus, or an image that has been subjected to specific processing on the original image, such as preliminary filtering, anti-aliasing, color adjustment, contrast adjustment, normalization, and so on. It should be pointed out that the pre-processing operations may also include other types of pre-processing operations known in the art, which will not be described in detail here.

In related technologies, a voice assistant only processes voice information, and thus has a relatively limited capability of processing user requirements. The interaction method and apparatus, the electronic device, and the computer-readable storage medium provided in the present disclosure implement more convenient and flexible interaction.

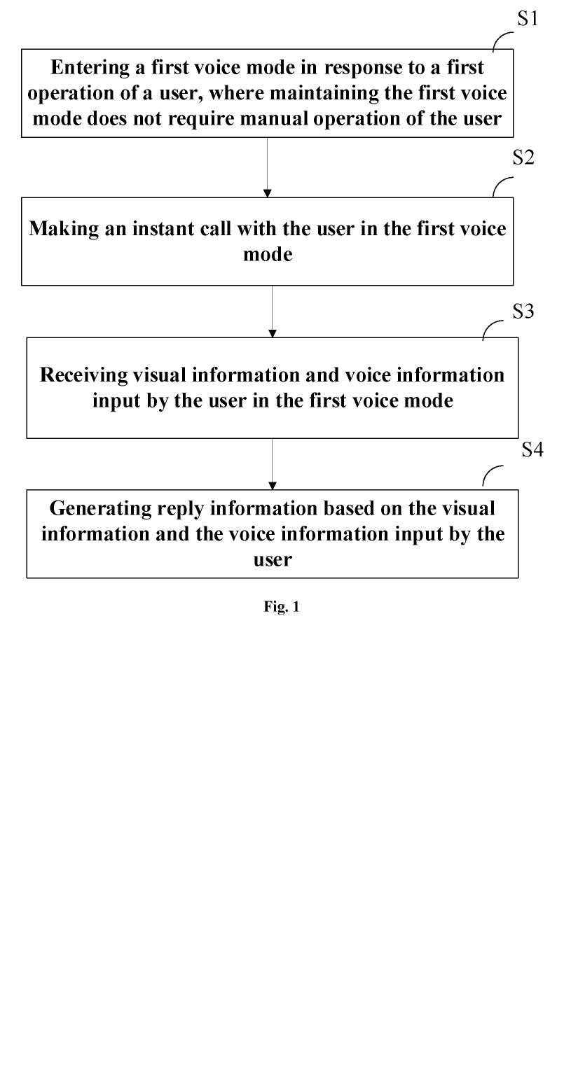

FIG. 1 is a schematic flowchart of an interaction method according to some embodiments of the present disclosure.

As shown in FIG. 1, the interaction method includes: Step S1, entering a first voice mode in response to a first operation of a user, where maintaining the first voice mode does not require manual operation of the user; Step S2, making an instant call with the user in the first voice mode; Step S3, receiving visual information and voice information input by the user in the first voice mode; and Step S4, generating reply information based on the visual information and the voice information input by the user.

For example, the first voice mode is entered in response to the user performing the first operation. After the first voice mode is entered, the voice assistant may automatically maintain the first voice mode without manual operation of a terminal by the user.

In the first voice mode, the voice assistant makes an instant call with the user, for example, the voice assistant may have a plurality of rounds of voice conversations with the user. Without continuous manual operation of the user, the voice assistant may reply in voice as long as the user asks a question. The voice information is received by a sensor such as a microphone.

The visual information is, for example, an image, a video, or the like. For example, the user may speak voice instructions and input the visual information through operations on a screen. The voice assistant may reply to the user based on both the instructions spoken by the user and the instructions from the screen. The reply information may include visual information and voice information.

In the first voice mode, the voice assistant may receive both voice information and visual information, and may reply based on both the voice information and the visual information. This voice mode implements multimodal interaction, and the user may interact with the system through a combination of voice and image, making the interaction more convenient and flexible.

The interaction method of this embodiment may be executed on a client, or may be partially executed on a server.

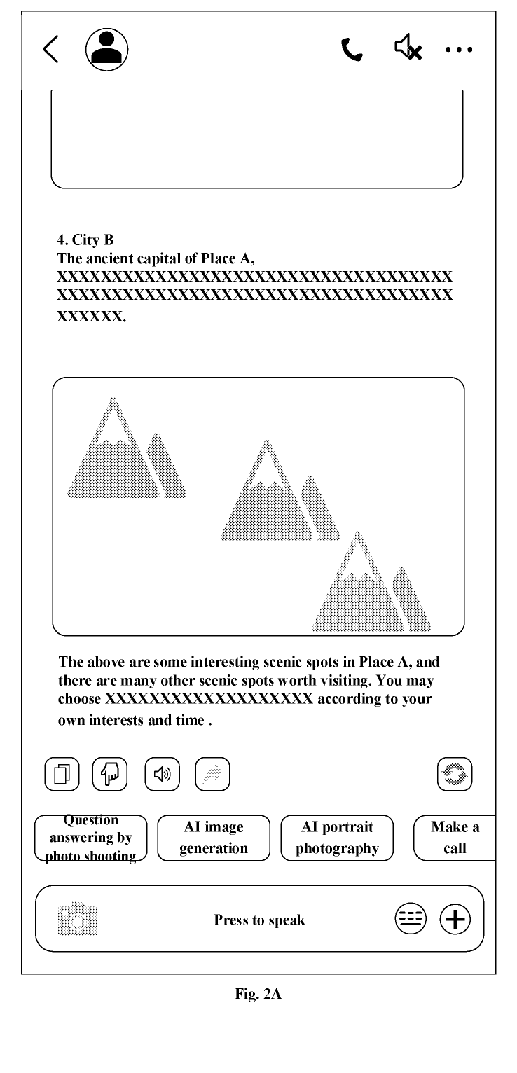

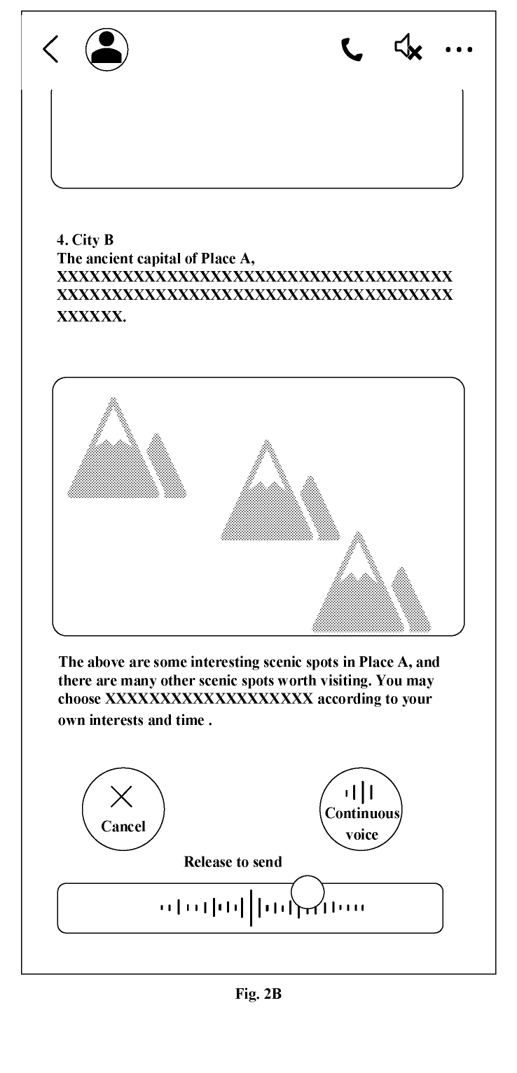

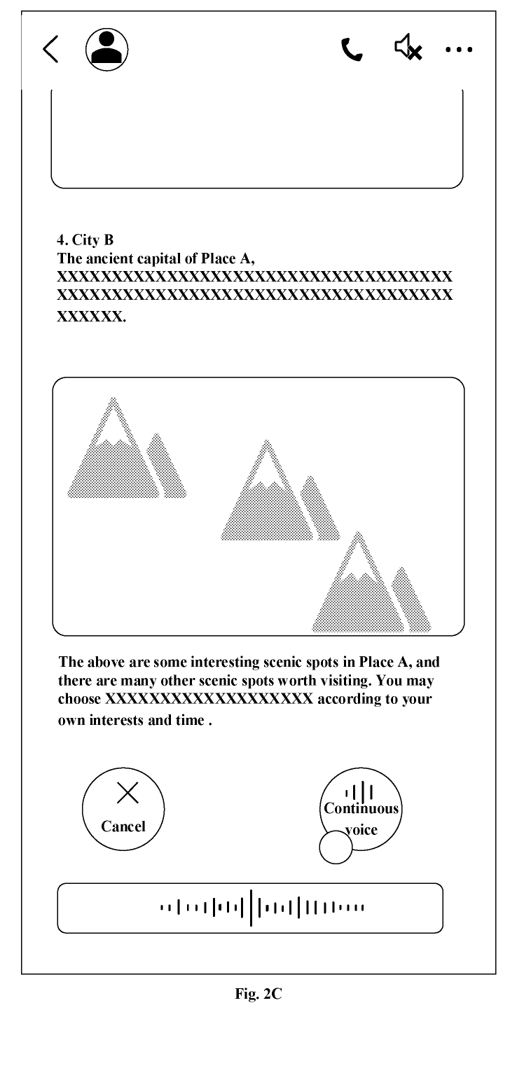

FIGS. 2A to 2C are schematic diagrams of entering a first voice mode according to some embodiments of the present disclosure.

A manner of entering the first voice mode according to some embodiments of the present disclosure is described below with reference to FIGS. 2A to 2C.

As shown in FIG. 2A, a first control may be displayed on an interaction interface. The first control is used for voice input, and is, for example, an identification for triggering voice input. The first control is, for example, "Press to speak" in FIG. 2A. When the user triggers "Press to speak", the interface shown in FIG. 2B is displayed. The second region is, for example, a region where "Continuous voice" is located in FIG. 2B. The white circle in FIG. 2B represents a position touched by the user.

The first voice mode is entered in response to the hand of the user moving from a first region to the second region. When the hand of the user moves to the second region, the interface shown in FIG. 2C is displayed. It may be seen that the finger of the user in FIG. 2C has moved to the region where "Continuous voice" is located.

After the finger of the user swipes on the screen from the first region (the bar-shaped region in FIG. 2B) to the second region (the region where "Continuous voice" is located in FIG. 2B), the first voice mode is entered. The first voice mode may be entered after it is detected that the finger of the user swipes to the second region and leaves the screen. The first voice mode may also be entered directly after it is detected that the finger of the user swipes to the second region.

After the first voice mode is entered, the user may release the hand, and the first voice mode may be automatically maintained.

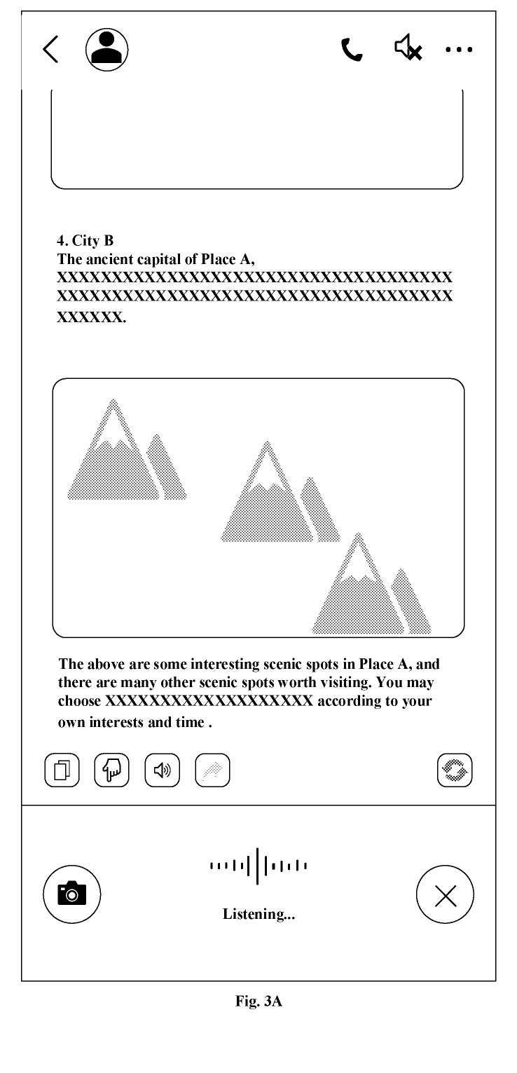

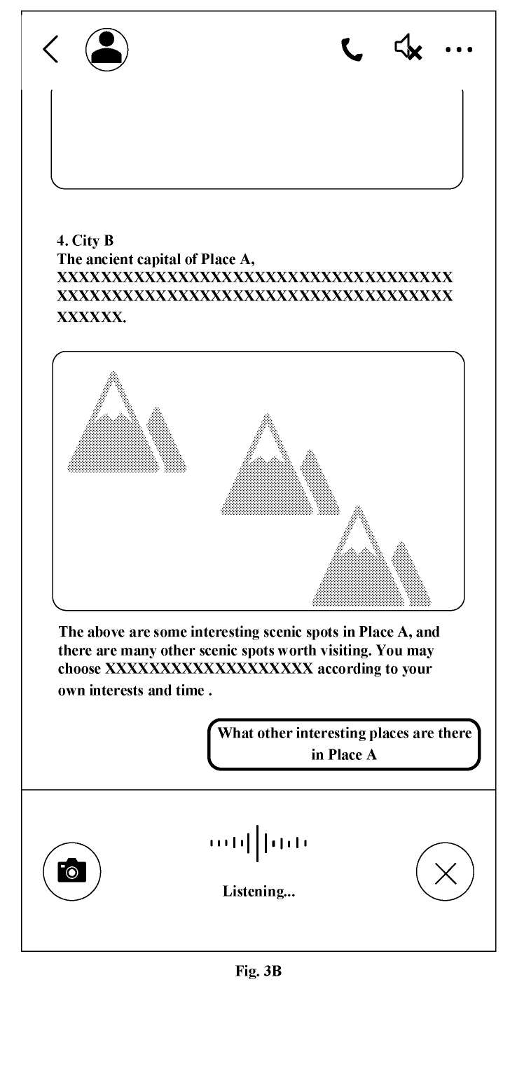

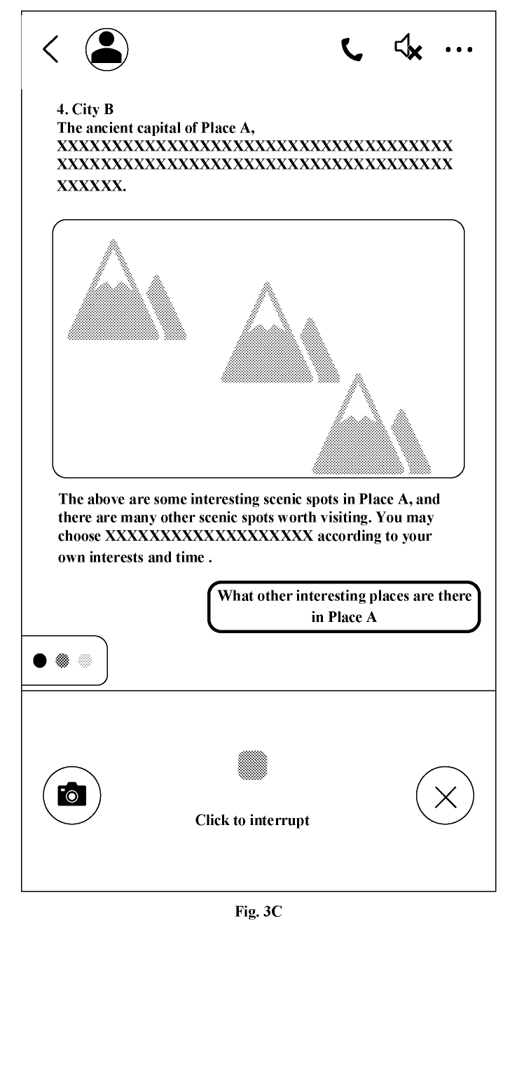

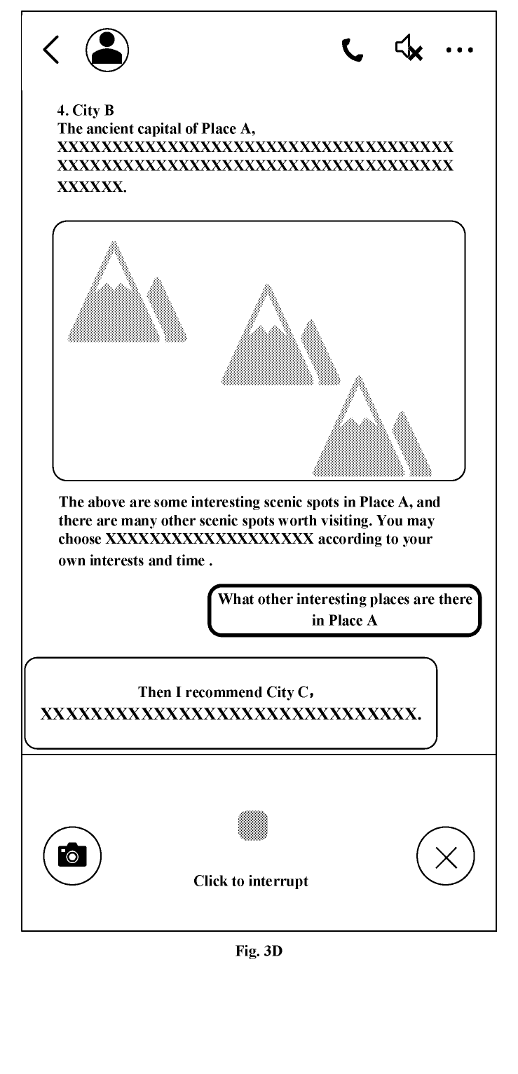

In the first voice mode, the call interface is as shown in, for example, FIGS. 3A to 3D.

The user may further ask questions about previous conversations, for example, the user has previously asked "What are the interesting places in place A", and may continue to ask "What other interesting places are there in place A".

As shown in FIG. 3A, when the user is speaking, "Listening" may be displayed on the call interface, so that the user may intuitively know that the first voice mode is operating normally and the system is receiving and processing the voice information of the user.

After it is detected that the user has completed voice input this time, the voice input of the user may be converted into text and displayed on the screen, as shown in, for example, FIG. 3B.

When waiting for the system to generate a reply, as shown in FIG. 3C, ellipsis may be displayed to indicate that the voice assistant is processing the question of the user, guiding the user to wait patiently.

The generated reply may be displayed as text on the screen, for example, "Then I recommend city C" is displayed in FIG. 3D. Moreover, reply voice may also be played to the user.

In the first voice mode, an exit button may be displayed on the call interface, for example, "X" on the right side of the screen in FIGS. 3A to 3D.

In the first voice mode, an option of starting a shooting function is displayed on the call interface. A picture shot by the user is determined as the visual information in response to the user starting the shooting function.

The option of starting the shooting function is, for example, a camera pattern in FIGS. 3A to 3D. By selecting the option of starting the shooting function, the user may invoke a camera to take photos, record videos, etc. The voice assistant may use the picture shot by the user as the visual information.

That is, the user may directly enter the shooting function from the first voice mode without exiting the first voice mode first and then entering the shooting function, thereby reducing the operation steps of the user and improving interaction efficiency.

In some embodiments, the method switches to a shooting interface in response to the user starting the shooting function; and switches back to the call interface and continues to make the instant call with the user in response to the user completing shooting on the shooting interface.

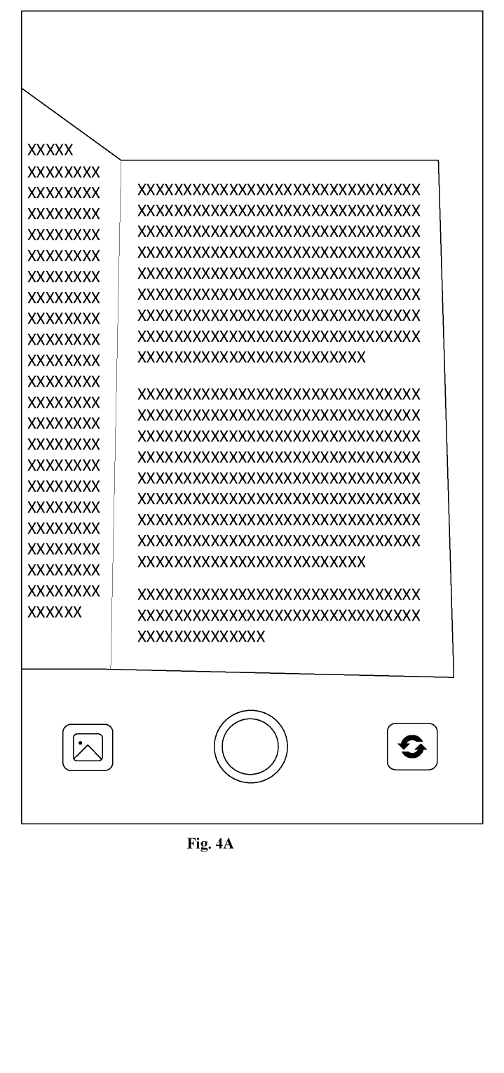

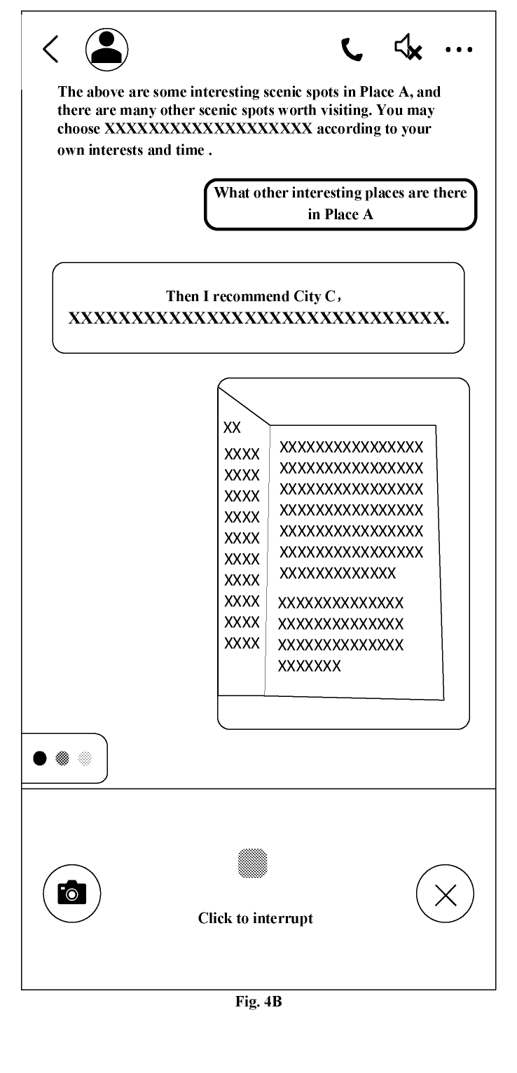

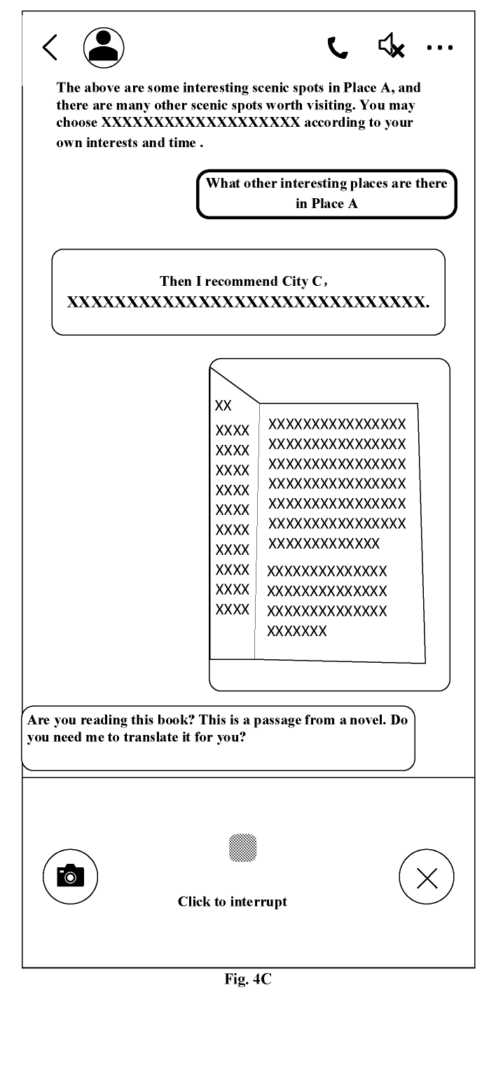

For example, when the user clicks on the camera pattern in FIGS. 3A to 3D, the shooting interface shown in FIG. 4A is entered. On the shooting interface, the user may click on a shooting button to shoot. After the user clicks on the shooting button and completes shooting, the call interface shown in FIG. 4B is directly returned to, and the instant call with the user continues. Moreover, the visual information input by the user may be displayed on the call interface shown in FIG. 4B.

That is, the call interface is automatically switched back to after shooting is completed, and the instant call with the user continues in the first voice mode. The user does not need to manually exit the shooting function and then re-enter the first voice mode, thereby reducing the operation steps of the user and improving interaction efficiency.

The voice assistant may also maintain the instant call with the user during the shooting process of the user.

For example, while the shooting interface shown in FIG. 4A is displayed, the voice assistant still receives voice input from the user or outputs voice replies. That is, the call with the user is not interrupted by the shooting action of the user. The user may freely switch to the camera application to take photos or record videos without hanging up the call, which reduces the inconvenience caused by frequent switching operations. Moreover, the call and shooting are performed at the same time, which improves the efficiency of multitasking.

After receiving the visual information, the voice assistant may wait for the user to input voice information related to the visual information, or may actively guide the user to perform voice input. The voice assistant may first invoke a visual recognition model to determine a type and content of the visual information. Then, the voice assistant may generate guidance information based on the type and content of the visual information. For example, as shown in FIG. 4C, the user inputs a picture of a book, and the text in the picture is different from the text used in the current conversation, the voice assistant outputs guidance information to the user in voice or text: "Are you reading this book? This is a passage from a novel. Do you need me to translate it for you?"

The user may also select visual information from a resource library (such as an image gallery) and send it to the voice assistant. A manner of selecting visual information from the resource library is described below.

In some embodiments, in the first voice mode, an option of starting a resource library is displayed on the call interface; and a visual resource selected by the user in the resource library is determined as the visual information in response to the user starting the resource library.

For example, an identification of an image gallery is displayed on the call interface. By selecting the identification of the image gallery, the user may enter the image gallery and browse images and videos in the image gallery. The voice assistant may use the image and video selected by the user in the image gallery as the visual information.

The user may directly enter the resource library from the first voice mode without exiting the first voice mode first and then entering the resource library, thereby reducing the operation steps of the user and improving interaction efficiency.

In some embodiments, the method switches to a display interface of the resource library in response to the user starting the resource library; and switches back to the call interface and continues to make the instant call with the user in response to the user completing selection of the visual resource on the display interface of the resource library.

That is, after the user completes selection in the resource library, the call interface is automatically switched back to, and the instant call with the user continues in the first voice mode. The user does not need to manually exit the resource library and then re-enter the first voice mode, thereby reducing the operation steps of the user and improving interaction efficiency.

The voice assistant may also maintain the instant call with the user during the operation of the user in the resource library.

That is, the call with the user is not interrupted by entering the resource library. The user may freely switch to the resource library without hanging up the call, which reduces the inconvenience caused by frequent switching operations. Moreover, the call and shooting are performed at the same time, which improves the efficiency of multitasking.

Both the option of starting the resource library and the option of starting the shooting function may be displayed on the call interface at the same time, or only one of them may be displayed. The option of starting the resource library may also be displayed on the shooting interface, as shown by the image gallery icon in the lower left corner of FIG. 4A. The option of starting the shooting function may also be displayed on the browsing interface of the resource library. That is, the camera application and the resource library may be switched between each other.

In some embodiments, a processing instruction for the visual information of the user is determined based on the voice information; and the visual information is processed based on the processing instruction to obtain the reply information.

For example, if the visual information input by the user is a picture and the voice information input by the user is a processing instruction for the picture, the picture is processed based on the processing instruction. The processing instruction for the picture may be an editing operation, such as cropping, modifying brightness, contrast, saturation, rotation, flipping, etc. The processing instruction for the picture may also be adding props to the picture, such as text, stickers, etc.

The processing instruction for the visual information may also be analyzing content in the visual information, summarizing text in the visual information, translating the text in the visual information, generating new visual information based on the input visual information, etc.

In some embodiments, the reply information is generated based on the voice information, the visual information, and a context of a conversation with the user.

For example, the user wants to get professional advice on clothing matching and gives voice instructions: "Please give me some suggestions for clothes matching suitable for wearing in summer". The voice assistant responds: "It is recommended that you choose a short-sleeved or three-quarter-sleeved shirt or knitted sweater as an inner layer under a coat, and it is also a good choice to match with high-waisted straight-leg pants or a pencil skirt."

The user continues to say: "Do you have other recommendations?" The voice assistant determines that the user may not like the previous recommendation and guides the user to input more information: "In order to give better advice, please tell me what style you usually like first?" Then, the user uploads a photo of his usual dress.

The intelligent assistant combines the previous voice instructions, determines that the user still needs summer dressing advice, and analyzes the picture, and thus generates a reply: "From your photo, you seem to like a casual and comfortable style. For summer, you may try to choose a light and breathable dress."

In some embodiments, in the first voice mode, a second control is displayed on the call interface; and in a case of playing the reply information, current playing of the reply information is interrupted in response to a triggering operation of the user on the second control, and voice input of the user continues to be detected.

For example, as shown in FIG. 3D, a "Click to interrupt" button may be displayed on the call interface.

For example, the voice assistant is explaining a certain complex question in detail, but the user has already found the information he needs and wants to ask a new question immediately. The user clicks on the "Click to interrupt" button on the screen, the voice of the voice assistant stops, and the user may be informed that the interrupting action has been completed through visual feedback (such as a change in button state).

In some embodiments, in the first voice mode, a text input area is displayed; and text information input by the user through the text input area is received.

For example, the user may input not only visual information through the screen, but also text information through the screen. The user may paste the copied text into the input box and input it to the voice assistant. By displaying the text input area in the first voice mode, the user may freely choose which information is input by text and which information is input by voice, providing a more flexible input manner.

In some embodiments, call information may also be displayed on the call interface, where the call information includes at least one of: voice information input by the user, text information corresponding to the voice information input by the user, the reply information, or visual information input by the user; and the call information is processed in response to a third operation of the user on the call information.

The voice information input by the user may be directly converted into text and displayed on the call interface. A mark of each piece of voice input by the user may also be displayed, and when the user triggers the mark, the corresponding voice is converted into text and displayed.

As shown in FIG. 5, the user may select a piece of call information by long pressing and operate on the call information. If the user selects text information, a selected text range may also be adjusted.

In some embodiments, in response to the third operation of the user on the call information, at least one of copying, deleting, saving, voice reading, translating, sharing, or image processing is performed on the call information.

For example, as shown in FIG. 5, in response to the user selecting a piece of call information, options such as copying, reading, and translating are displayed, and the user may perform corresponding operations by triggering these options.

In some embodiments, the first voice mode is switched to running in the background in response to a fifth operation of the user.

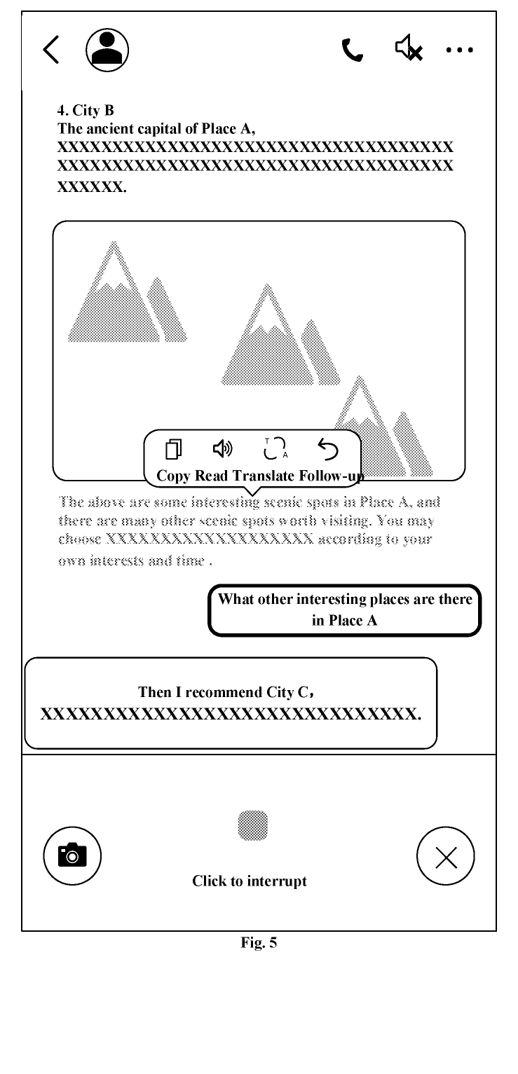

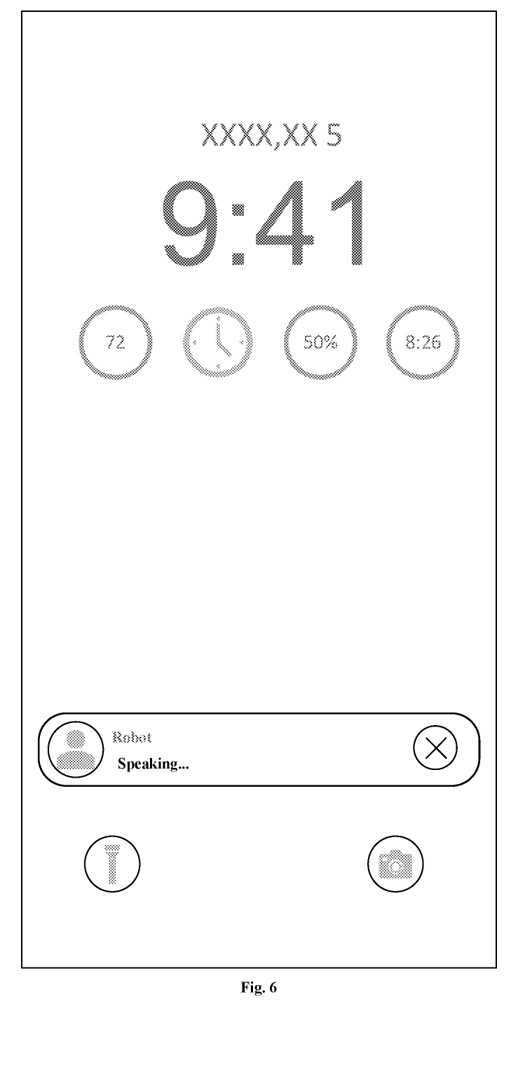

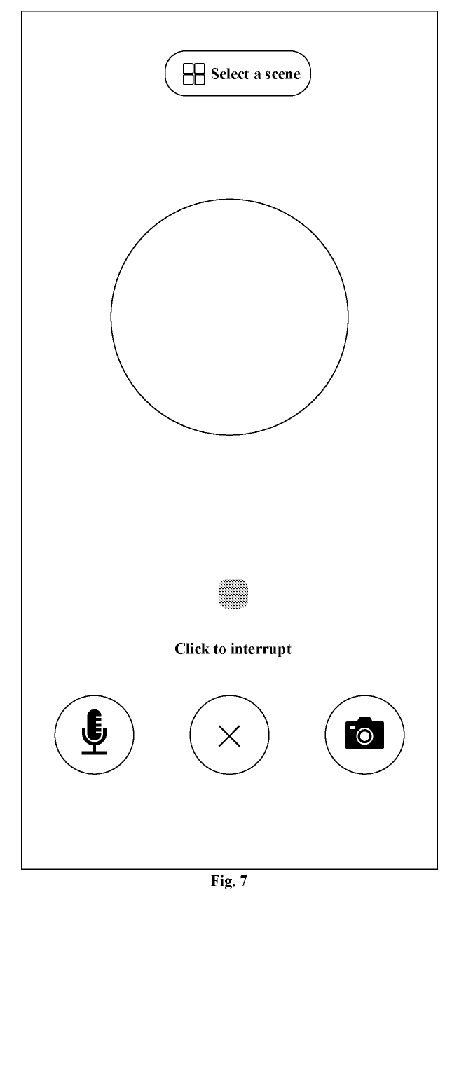

For example, as shown in FIG. 6, if the user locks the screen, prompt information of the first voice mode is displayed in the screen locked state. In the screen locked state, if the user gives voice instructions, the voice assistant may quickly respond. If the user switches to other applications, the voice assistant may also switch to running in the background while the user is using other applications. The user may continuously interact with the voice assistant without the conversation being interrupted due to application switching.

In some embodiments, the interaction method further includes: exiting the first voice mode in response to no voice input of the user being received within a first designated duration.

For example, by analyzing features such as sound intensity and frequency distribution in an audio signal, a voice segment and a silent segment are automatically identified. When a period of continuous silence is detected, the system considers that the user has ended the conversation and exits the first voice mode.

According to some embodiments of the present disclosure, the voice assistant further provides a second voice mode, which is described below.

The second voice mode is entered in response to a second operation of the user, where maintaining the second voice mode requires the user to continuously trigger a first control in a first region; voice information input by the user is received in the second voice mode; and the second voice mode is exited in response to the user ending triggering of the first control.

For example, as shown in FIG. 2B, the user presses the first control, and at this time, the device starts recording the voice of the user. As long as the user keeps the button pressed, recording will continue. After the user finishes speaking, the button is released, and the device stops recording and converts the recorded voice segment into a voice message and sends it to the voice assistant.

In the interface of FIG. 2B, after triggering the first control, the user maintains the second voice mode if the user keeps continuously triggering the first control in the first region, and enters the first voice mode if the user swipes from the first region to a second region. That is, the user may conveniently and quickly switch from the second voice mode to the first voice mode.

According to some embodiments of the present disclosure, the voice assistant further provides a third voice mode, which is described below.

Switching to the third voice mode in response to a fourth operation of the user in the first voice mode includes: switching to the third voice mode in response to detecting a swiping operation of the user from a third region to a fourth region in the first voice mode.

For example, in the first voice mode, the user swipes his finger upward from the bottom of the screen to enter the third voice mode.

Maintaining the third voice mode does not require manual operation of the user; in the third voice mode, a virtual image is displayed and the instant call with the user is made; and the third voice mode is exited in response to no voice input of the user being received within a second designated duration, where the second designated duration is greater than the first designated duration.

For example, in the third voice mode, the user also does not need continuous hand operation to maintain the mode. In the third voice mode, a virtual image of the voice assistant may also be displayed, and when the voice assistant speaks, lip movement, facial expression, and body language of the virtual image may be synchronized with voice, providing a more natural, smooth, and immersive conversation experience.

Moreover, in the third voice mode, if the user does not speak for a long time, the third voice mode may be exited. Compared with the third voice mode, the user silence duration that needs to be satisfied to exit the first voice mode is shorter. There are fewer operations to enter the first voice mode than to enter the third voice mode, and the user may enter faster, that is, the cost of entering and exiting the first voice mode is lower.

The first voice mode may be used for a quick and efficient conversation and exiting in time. The third voice mode may be used for a long conversation, giving the user more time to think.

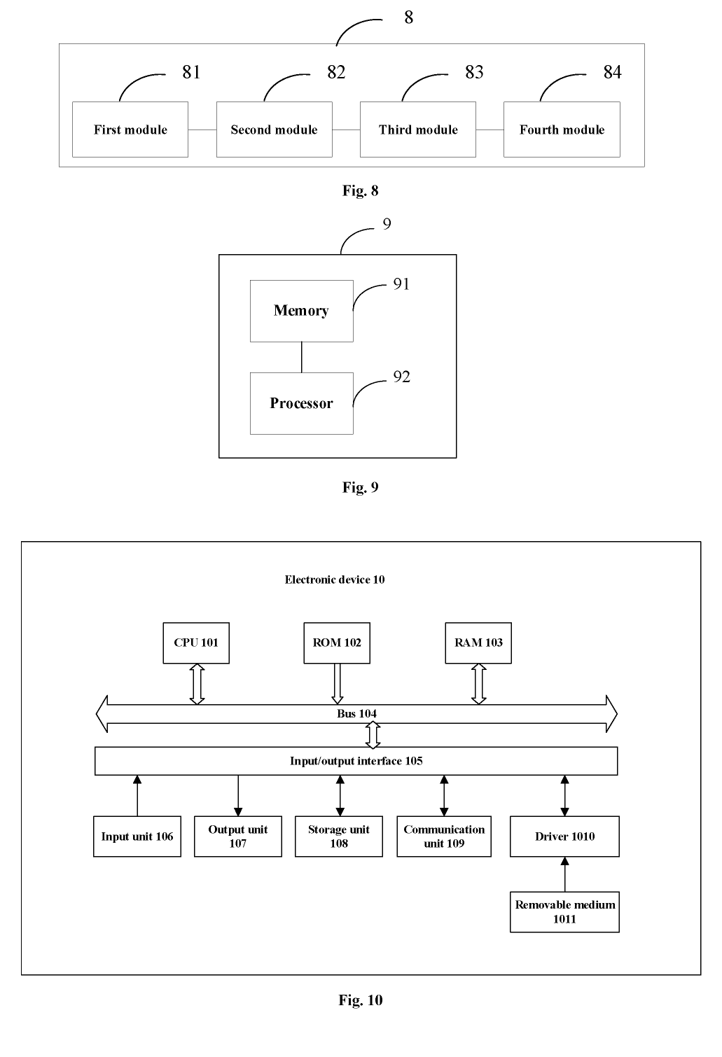

FIG. 8 shows a block diagram of an interaction apparatus according to some embodiments of the present disclosure.

As shown in FIG. 8, the interaction apparatus 8 includes: a first module 81 configured to enter a first voice mode in response to a first operation of a user, where maintaining the first voice mode does not require manual operation of the user; an 82 second module configured to make an instant call with the user in the first voice mode; a third module 83 configured to receive visual information and voice information input by the user in the first voice mode; and a fourth module 84 configured to generate reply information based on the visual information and the voice information input by the user.

The first module 81 of the interaction apparatus 8 may be used to perform Step S1 in FIG. 1. The second module 82 may be used to perform Step S2 in FIG. 1. The third module 83 may be used to perform Step S3 in FIG. 1. The fourth module 84 may be used to perform Step S4 in FIG. 1.

In some embodiments, the interaction apparatus further includes: a fifth module configured to enter a second voice mode in response to a second operation of the user, where maintaining the second voice mode requires the user to continuously trigger a first control in a first region; receive voice information input by the user in the second voice mode; and exit the second voice mode in response to the user ending triggering of the first control.

In some embodiments, the interaction apparatus further includes: a sixth module configured to, in the first voice mode, display a second control on a call interface; and in a case of playing the reply information, interrupt current playing of the reply information in response to a triggering operation of the user on the second control, and continue to detect voice input of the user.

In some embodiments, the interaction apparatus further includes: a seventh module configured to display call information, where the call information includes at least one of: voice information input by the user, text information corresponding to the voice information input by the user, the reply information, or visual information input by the user; and process the call information in response to a third operation of the user on the call information.

In some embodiments, the interaction apparatus further includes: an eighth module configured to exit the first voice mode in response to no voice input of the user being received within a first designated duration.

In some embodiments, the interaction apparatus further includes: a ninth module configured to switch to a third voice mode in response to a fourth operation of the user in the first voice mode, where maintaining the third voice mode does not require manual operation of the user; display a virtual image and make the instant call with the user in the third voice mode; and exit the third voice mode in response to no voice input of the user being received within a second designated duration, where the second designated duration is greater than the first designated duration.

In some embodiments, the interaction apparatus further includes: a tenth module configured to display call information, where the call information includes at least one of: voice information input by the user, text information corresponding to the voice information input by the user, the reply information, or visual information input by the user; and process the call information in response to a third operation of the user on the call information.

In some embodiments, the interaction apparatus further includes: an eleventh module configured to switch to running the first voice mode in the background in response to a fifth operation of the user.

FIG. 9 shows a block diagram of an electronic device according to some embodiments of the present disclosure.

The memory 91 is configured to store one or more computer-readable instructions. The memory 91 may include any combination of various forms of computer-readable storage media, such as volatile memory and/or non-volatile memory, including but not limited to random access memory (RAM), dynamic random access memory (DRAM), static random access memory (SRAM), read-only memory (ROM), and flash memory. The memory 91 may store, for example, an operating system, applications, a boot loader, a database, and other programs, and may also store various applications, various data, and the like.

The processor 92 is configured to run the computer-readable instructions to implement the song screening method of any of the above embodiments or the method of any of the above embodiments. For the specific implementation of each step of the method, reference may be made to the above embodiments, and the repeated parts are not described herein.

The processor 92 may be configured to perform the steps in FIG. 1. The processor 92 may be embodied as various processing apparatuses, such as a central processing unit (CPU), a network processor (NP), etc.; and may also be a digital signal processor (DSP), an application specific integrated circuit (ASIC), a field programmable gate array (FPGA) or other programmable logic devices, a discrete gate or transistor logic device, or a discrete hardware component. The central processing unit (CPU) may have an X86 or ARM architecture or the like.

The processor 92 and the memory 91 may directly or indirectly communicate with each other. For example, the processor 92 and the memory 91 may communicate through a network. The network may include a wireless network, a wired network, and/or any combination of wireless and wired networks. The processor 92 and the memory 91 may also communicate with each other through a system bus, which is not limited by the present disclosure.

It should be noted that the components of the electronic device 9 shown in FIG. 9 are only exemplary and non-restrictive, and the electronic device 9 may have other components according to actual application requirements. The processor 92 may control other components in the electronic device 9 to perform desired functions.

The electronic device 9 may be implemented by software, firmware, and/or hardware, and may be integrated in an apparatus installed with relevant applications.

FIG. 10 shows a block diagram of an electronic device according to some other embodiments of the present disclosure.

The electronic device 10 shown in FIG. 10 may be a computer system having a dedicated hardware structure, and may perform corresponding functions when installed with relevant applications.

The electronic device includes, but is not limited to, mobile terminals such as smartphones, notebooks, personal digital assistants (PDAs), tablet personal computers (Tablet PCs), portable media players (PMPs), vehicle terminals (such as car navigation terminals), and wearable devices, and fixed terminals such as digital TVs and desktop computers.

As shown in FIG. 10, a central processing unit (CPU) 101 executes various processes based on a program stored in a read-only memory (ROM) 102 or a program loaded from a storage unit 108 into a random access memory (RAM) 103. The RAM 103 stores therein data required when the CPU 101 executes the various processes and the like, as needed. The central processing unit is merely exemplary, and it may be other types of processors, such as the various processors described above. The ROM 102, the RAM 103, and the storage unit 108 may be various forms of computer-readable storage media. It should be noted that although the ROM 102, the RAM 103, and the storage unit 108 are shown separately in FIG. 10, one or more of them may be combined or located in the same or different memories or storage modules.

The CPU 101, the ROM 102, and the RAM 103 are connected to each other via a bus 104. An input/output interface 105 is also connected to the bus 104.

The following components are connected to the input/output interface 105: an input unit 106 such as a touch screen, a touchpad, a keyboard, a mouse, an image sensor, a microphone, an accelerometer, and a gyroscope; an output unit 107 including a display such as a cathode ray tube (CRT) and a liquid crystal display (LCD), a speaker, a vibrator, and the like; the storage unit 108 including a hard disk, a magnetic tape, and the like; and a communication unit 109 including a network interface card such as a LAN card and a modem. The communication unit 109 allows communication processing to be performed via a network such as the Internet. It is easily understood that although some components in the electronic device 10 shown in FIG. 10 communicate through the bus 104, they may also communicate through a network or other means, where the network may include a wireless network, a wired network, and/or any combination of wireless and wired networks.

A driver 1010 is also connected to the input/output interface 105 as needed. A removable medium 1011 such as a magnetic disk, an optical disc, a magneto-optical disc, and a semiconductor memory is mounted on the driver 1010 as needed, so that a computer program read therefrom is installed into the storage unit 108 as needed.

In the case where the above-described series of processes are implemented by software, a program constituting the software may be installed from a network such as the Internet or a storage medium such as the removable medium 1011.

According to the embodiments of the present disclosure, the processes described above with reference to the flowcharts may be implemented as computer software programs. For example, some embodiments of the present disclosure include a computer program product that, when running on a computer, causes the computer to implement the method of any of the above embodiments. The computer program product includes computer instructions carried on a computer-readable medium, including program code for performing the method shown in the flowchart. In such an embodiment, the computer instructions may be downloaded and installed from a network through the communication unit 109, or installed from the storage unit 108, or installed from the ROM 102. When the computer program is executed by the CPU 101, the method of the embodiments of the present disclosure is executed.

It should be noted that in the context of the present disclosure, a computer-readable medium may be a tangible medium that may contain or store a program to be used by or in combination with an instruction execution system, apparatus, or device.

The computer-readable medium may be a computer-readable storage medium, a computer-readable signal medium, or any combination of the two.

The computer-readable storage medium includes, but is not limited to, an electrical, magnetic, optical, electromagnetic, infrared, or semiconductor system, apparatus, or device, or any suitable combination of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus, or device. The computer-readable storage medium has computer instructions stored thereon, and when the instructions are executed by a processor, the method of any of the above embodiments is implemented.

The computer-readable signal medium may include a data signal propagated on a baseband or as a part of a carrier, and computer-readable program code is carried in the data signal. The data signal propagated in this manner may be in various forms, including, but not limited to, an electromagnetic signal, an optical signal, or any suitable combination of the above. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted in any suitable medium, including, but not limited to, a wire, an optical cable, a radio frequency (RF), or any suitable combination of the above.

The above computer-readable medium may be included in the above electronic device, or may exist alone without being assembled into the electronic device.

In some embodiments, there is further provided a computer program, including: instructions that, when executed by a processor, cause the processor to perform the method of any of the above embodiments. For example, the instructions may be embodied as computer program code.

In the embodiments of the present disclosure, the computer program code for performing the operations of the present disclosure may be written in one or more programming languages or a combination thereof. The above programming languages include but are not limited to object-oriented programming languages such as Java, Smalltalk, and C++, and include conventional procedural programming languages such as "C" language or similar programming languages. The program code may be executed entirely on a user computer, partly executed on a user computer, executed as an independent software package, partly executed on a user computer and partly executed on a remote computer, or entirely executed on a remote computer or server. In the case of involving a remote computer, the remote computer may be connected to the user computer through any kind of network, including a local area network (LAN) or a wide area network (WAN), or may be connected to an external computer (for example, connected by using Internet provided by an Internet service provider).

The flowcharts and block diagrams in the drawings illustrate the possibly implemented architectures, functions, and operations of the system, method and computer program product according to various embodiments of the present disclosure. In this regard, each block in the flowchart or block diagrams may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may, in fact, be executed substantially concurrently, or the blocks may sometimes be executed in the reverse order, depending upon the functionality involved. It should also be noted that each block of the block diagrams and/or flowcharts, and combinations of blocks in the block diagrams and/or flowcharts may be implemented by special purpose hardware-based systems that perform the specified functions or operations, or may be implemented by combinations of special purpose hardware and computer instructions.

The functions described above may be performed at least in part by one or more hardware logic components. For example, without limitation, exemplary hardware logic components that may be used include: a field programmable gate array (FPGA), an application specific integrated circuit (ASIC), an application specific standard product (ASSP), a system on chip (SOC), a complex programmable logical device (CPLD), and the like.

Although some specific embodiments of the present disclosure have been described in detail by way of examples, those skilled in the art should understand that the above examples are only for illustration, and are not intended to limit the scope of the present disclosure. Those skilled in the art should understand that the above embodiments may be modified without departing from the scope and spirit of the present disclosure. The scope of the present disclosure is defined by the appended claims.

1. An interaction method, comprising:
entering a first voice mode in response to a first operation of a user, wherein maintaining the first voice mode does not require manual operation of the user;
making an instant call with the user in the first voice mode;
receiving visual information and voice information input by the user in the first voice mode; and
generating reply information based on the visual information and the voice information input by the user.

2. The interaction method of claim 1, wherein receiving the visual information and the voice information input by the user in the first voice mode comprises:
in the first voice mode, displaying an option of starting a shooting function on a call interface; and
determining a picture shot by the user as the visual information in response to the user starting the shooting function.

3. The interaction method of claim 2, wherein determining the picture shot by the user as the visual information in response to the user starting the shooting function comprises:
switching to a shooting interface in response to the user starting the shooting function; and
switching back to the call interface and continuing to make the instant call with the user in response to the user completing shooting on the shooting interface.

4. The interaction method of claim 2, wherein receiving the visual information and the voice information input by the user in the first voice mode comprises:
maintaining the instant call with the user during a shooting process of the user.

5. The interaction method of claim 1, wherein receiving the visual information and the voice information input by the user in the first voice mode comprises:
in the first voice mode, displaying an option of starting a resource library on a call interface; and
determining a visual resource selected by the user in the resource library as the visual information in response to the user starting the resource library.

6. The interaction method of claim 5, wherein determining the visual resource selected by the user in the resource library as the visual information in response to the user starting the resource library comprises:
switching to a display interface of the resource library in response to the user starting the resource library; and
switching back to the call interface and continuing to make the instant call with the user in response to the user completing selection of the visual resource on the display interface of the resource library.

7. The interaction method of claim 5, wherein receiving the visual information and the voice information input by the user in the first voice mode comprises:
maintaining the instant call with the user during an operation process of the user in the resource library.

8. The interaction method of claim 1, wherein generating the reply information based on the visual information and the voice information input by the user comprises:
determining a processing instruction for the visual information of the user based on the voice information; and
processing the visual information based on the processing instruction to obtain the reply information.

9. The interaction method of claim 1, wherein generating the reply information based on the visual information and the voice information input by the user comprises:
generating the reply information based on the voice information, the visual information, and context of a conversation with the user.

10. The interaction method of claim 1, wherein entering the first voice mode in response to the first operation of the user comprises:
displaying a first control, wherein the first control is configured for voice input; and
entering the first voice mode in response to a hand of the user moving from a first region to a second region.

11. The interaction method of claim 10, further comprising:
entering a second voice mode in response to a second operation of the user, wherein maintaining the second voice mode requires the user to continuously trigger the first control in the first region;
receiving voice information input by the user in the second voice mode; and
exiting the second voice mode in response to the user ending triggering of the first control.

12. The interaction method of claim 1, further comprising:
in the first voice mode, displaying a second control on a call interface, and in a state of playing the reply information, interrupting current playing of the reply information in response to a triggering operation of the user on the second control, and continuing to detect voice input of the user; and/or
switching to running the first voice mode in the background in response to a fifth operation of the user.

13. The interaction method of claim 1, wherein receiving the visual information and the voice information input by the user in the first voice mode comprises:
in the first voice mode, displaying a text input area; and
receiving text information input by the user through the text input area.

14. The interaction method of claim 1, further comprising:
displaying call information, wherein the call information comprises at least one of voice information input by the user, text information corresponding to the voice information input by the user, the reply information, or visual information input by the user; and
processing the call information in response to a third operation of the user on the call information.

15. The interaction method of claim 14, wherein processing the call information in response to the third operation of the user on the call information comprises:
performing at least one of copying, deleting, saving, voice reading, translating, sharing, or image processing on the call information in response to the third operation of the user on the call information.

16. The interaction method of claim 1, further comprising:
exiting the first voice mode in response to no voice input of the user being received within a first designated duration.

17. The interaction method of claim 16, further comprising:
switching to a third voice mode in response to a fourth operation of the user in the first voice mode, wherein maintaining the third voice mode does not require manual operation of the user;
displaying a virtual image and making an instant call with the user in the third voice mode; and
exiting the third voice mode in response to no voice input of the user being received within a second designated duration, wherein the second designated duration is greater than the first designated duration.

18. The interaction method of claim 16, wherein switching to the third voice mode in response to the fourth operation of the user in the first voice mode comprises:
in the first voice mode, switching to the third voice mode in response to detecting a swiping operation of the user from a third region to a fourth region.

19. An electronic device, comprising:
at least one memory; and
at least one processor coupled to the memory, wherein the processor is configured to, based on instructions stored in the memory, execute an interaction method, comprising:
entering a first voice mode in response to a first operation of a user, wherein maintaining the first voice mode does not require manual operation of the user;
making an instant call with the user in the first voice mode;
receiving visual information and voice information input by the user in the first voice mode; and
generating reply information based on the visual information and the voice information input by the user.

20. A non-transitory computer-readable storage medium having computer program instructions stored thereon, which when the instructions are executed by a processor, implements an interaction method comprising:
entering a first voice mode in response to a first operation of a user, wherein maintaining the first voice mode does not require manual operation of the user;
making an instant call with the user in the first voice mode;
receiving visual information and voice information input by the user in the first voice mode; and
generating reply information based on the visual information and the voice information input by the user.
